(19) United States
(12) Patent Application Publication
(10) Pub. No.: US 2024/0013935 A1
(43) Pub. Date: Jan. 11, 2024

(54) Core of Fast Reactor

(71) Applicant: Hitachi-GE Nuclear Energy, Ltd., Hitachi-shi (JP)

(72) Inventors: Kouji FUJIMURA, Tokyo (JP); Junichi MIWA, Tokyo (JP); Sho FUCHITA, Hitachi-shi (JP)

(21) Appl. No.: 18/217,077

(22) Filed: Jun. 30, 2023

(30) Foreign Application Priority Data
Jul. 6, 2022 (JP) 2022-108926

(51) Int. Cl. G21C 1/02; G21C 15/28; G21C 3/22

(52) U.S. Cl. CPC G21C 1/022; G21C 15/28; G21C 3/22

(57) ABSTRACT

There is provided a core of a fast reactor capable of achieving a sodium-cooled metal fuel fast reactor with high adaptability to a molten salt heat storage system, by flattening the output distribution and raising the coolant outlet temperature while suppressing deterioration of the core characteristic. A core of a fast factor is a fuel assembly obtained by densely disposing fuel rods within a wrapper tube, the fuel rod storing, within a cladding tube, hollow fuel in which Pu-enrichment is made to be a predetermined value within a range of 11 to 13 wt %. In the core of a fast factor, a first fuel assembly including a fuel rod with a large hollow diameter of the hollow fuel is loaded on the center side of the core, and a second fuel assembly including a fuel rod with a hollow diameter smaller than the hollow diameter of the hollow fuel of the first fuel assembly is loaded on the circumferential side of the core.

### CLAIM OF PRIORITY

The present application claims priority from Japanese Patent application serial No. 2022-108926, filed on Jul. 6, 2022, the content of which is hereby incorporated by reference into this application.

### FIELD OF THE INVENTION

The present invention relates to a core of a sodium-cooled metal fuel fast reactor making high the coolant exit temperature of a nuclear reactor and increasing adaptability to the heat storage system using a molten salt.

### BACKGROUND OF THE INVENTION

With respect to a fuel assembly and a core of a fast reactor, it is general in a fast-breeder reactor that a core is disposed within a reactor vessel and liquid sodium which is the coolant is filled within the reactor vessel. The fuel assembly loaded on the core includes: plural fuel rods encapsulated with plutonium-enriched depleted uranium (U-238); a wrapper tube surrounding the bundled plural fuel rods; an entrance nozzle supporting a neutron shield positioned at the lower end portion of these fuel rods and below the fuel rods; and a coolant flow out portion positioned above the fuel rods.

The core of the fast-breeder reactor includes a core fuel region, a blanket fuel region, and a shield region. The core fuel region includes an inner core region and an outer core region that surrounds the inner core region, the blanket fuel region surrounds the core fuel region, and the shield region surrounds the blanket fuel region. In the case of a normal homogeneous core, the Pu-enrichment of the fuel assembly loaded on the outer core region is higher than the Pu-enrichment of the fuel assembly loaded on the inner core region. As a result, the output distribution in the radial direction of the core is flattened.

As the form of the nuclear fuel material stored in each fuel rod of the fuel assembly, there are metal fuel, nitride fuel, and oxide fuel. Among them, the oxide fuel is richest in the actual performance.

Pellets of the mixed oxide fuel namely the MOX fuel obtained by mixing oxide of each of Pu and depleted uranium are filled to a height of approximately 80-100 cm at the center portion in the axial direction within the fuel rod. Also, within the fuel rod, blanket regions in the axial direction filled with multiple uranium dioxide pellets made of depleted uranium are disposed above and below the filled region of the MOX fuel respectively. The inner core fuel assembly loaded on the inner core region and the outer core fuel assembly loaded on the outer core region include plural fuel rods filled with plural pellets of the MOX fuel that way. The Pu-enrichment of the outer core fuel assembly is higher than the Pu-enrichment of the inner core fuel assembly.

On the blanket fuel region surrounding the core fuel region, there is loaded a blanket fuel assembly that includes plural fuel rods filled with plural uranium dioxide pellets made of depleted uranium. Out of neutrons generated by a nuclear fission reaction occurring within the fuel assembly loaded on the core fuel region, neutrons leaked from the core fuel region are absorbed to U-238 within each fuel rod of the blanket fuel assembly loaded on the blanket fuel region. As a result, Pu-239 that is a fissile nuclide is newly generated within each fuel rod of the blanket fuel assembly.

Also, at the time of starting and shutting-down the fast-breeding reactor and at the time of adjusting the nuclear reactor output, a control rod is used. The control rod includes plural neutron absorber rods where boron carbide (B 4 C) pellets are filled in a cladding tube made of stainless steel, and is configured such that these neutron absorber rods are stored in a wrapper tube having regular hexagonal cross section, similarly to the inner core fuel assembly and the outer core fuel assembly. The control rod is configured of two independent systems of the main reactor shutdown system and the rear reactor shutdown system, and emergency shutdown of the fast-breeder reactor is enabled only by either one of the main reactor shutdown system and the rear reactor shutdown system.

Toward achievement of carbon neutral of the year 2050, adaptability to load fluctuation accompanying massive introduction of renewable energy is required for nuclear power generation. In the United States, there is proposed a plant dealing with load fluctuation by attaching a heat storage system using molten salt having actual performance in solar power generation to a small-sized sodium-cooled metal fuel fast reactor. From the viewpoint of securing integrity of the metal fuel, it is common in the metal fuel fast reactor that the primary system coolant outlet temperature of the nuclear reactor is designed to be approximately 50° C. lower compared to the oxide fuel fast reactor, and approximately 500° C. is assumed in a case of the small-sized sodium-cooled metal fuel fast reactor which is the main object of the present invention. On the other hand, in a case of nitrate-system molten salt used in the heat storage system having actual performance in the solar power generation described above, from the condition of the melting point of the molten salt and the temperature of a tank on the high temperature side of the heat storage system, it is desirable that the nuclear reactor coolant outlet temperature is made to be approximately 540° C. to 550° C.

In order to improve the coolant outlet temperature of the sodium-cooled metal fuel fast reactor, it is required to flatten the output distribution, to suppress useless flow rate, and to reduce the flow rate of the coolant. In order to flatten the output distribution, there is shown, in Japanese Patent Unexamined Publication No. 2005-083966, a method of making Pu-enrichment of all core fuel to be of one kind and making Zr content of the inner core to be higher than Zr content of the metal fuel U—Pu—Zr of the outer core where neutrons leak largely.

However, in the core of the metal fuel fast reactor making the Pu-enrichment of all core fuel to be of one kind shown in Japanese Patent Unexamined Publication No. 2005-083966, when Zr-content of the metal fuel of the inner core is made higher than that of the outer core, since the inventory of the heavy metal (U and Pu) of the inner core reduces, there occurs a problem that the fuel inventory reduces and the core characteristic such as the breeding ratio and the burnup reactivity deteriorates.

Therefore, the present invention is to provide a core of a fast reactor capable of achieving a sodium-cooled metal fuel fast reactor with high adaptability to a molten salt heat storage system by flattening the output distribution and raising the coolant outlet temperature while suppressing deterioration of the core characteristic.

### SUMMARY OF THE INVENTION

In order to solve the problem described above, a core of a fast reactor related to the present invention is a fuel assembly obtained by densely disposing fuel rods within a wrapper tube, the fuel rod storing, within a cladding tube, hollow fuel in which Pu-enrichment is made to be a predetermined value within a range of 11 to 13 wt %. In the core of a fast reactor, a first fuel assembly including a fuel rod with a large hollow diameter of the hollow fuel is loaded on the center side of the core, and a second fuel assembly including a fuel rod with a hollow diameter smaller than the hollow diameter of the hollow fuel of the first fuel assembly is loaded on the circumferential side of the core.

According to the present invention, it is possible to provide a core of a fast reactor capable of achieving a sodium-cooled metal fuel fast reactor with high adaptability to a molten salt heat storage system by flattening the output distribution and raising the coolant outlet temperature while suppressing deterioration of the core characteristic.

For example, by using a hollow fuel where Pu-enrichment of a fuel loaded on a core fuel assembly of a fast reactor is made constant within a range of 11 to 13 wt %, loading fuel assemblies with a large hollow diameter of the hollow fuel on the center side of the core, and loading fuel assemblies with a small hollow diameter of the hollow fuel on the circumferential side of the core, it is possible to achieve a core of a sodium-cooled metal fuel fast reactor with high adaptability to a molten salt heat storage system suppressing spatial and temporal fluctuation of the output distribution, excluding useless flow rate, and raising the nuclear reactor coolant outlet temperature without deteriorating the characteristic of the core.

Problems, configurations, and effects other than those described above will be clarified by description of embodiments described below.

### BRIEF DESCRIPTION OF THE DRAWINGS

FIG. 1A is a horizontal cross-sectional view of an inner core fuel assembly of a fast reactor related to the first embodiment of the present invention.

FIG. 1B is a horizontal cross-sectional view of an outer core fuel assembly of the fast reactor related to the first embodiment of the present invention.

FIG. 1C is a horizontal cross-sectional view of a ½ core of the fast reactor related to the first embodiment of the present invention where the inner core fuel assemblies and the outer core assemblies are loaded.

FIG. 2 is a vertical cross-sectional view of the inner core fuel assembly and the outer core fuel assembly illustrated in FIG. 1A, FIG. 1B, and FIG. 1C.

FIG. 3 is a drawing illustrating burnup dependability of the neutron infinite multiplication factor of the core fuel assembly of the fast reactor using Pu-enrichment as a parameter.

FIG. 4 is a drawing illustrating Pu-enrichment dependability of the maximum reactivity change during a burnup period.

FIG. 5 is a drawing illustrating burnup dependability of the neutron infinite multiplication factor of the metal fuel assembly using the fuel volume fraction as a parameter.

FIG. 6 is a vertical cross-sectional view of a core in a fast reactor related to the second embodiment of the present invention.

FIG. 7 is a vertical cross-sectional view of the inner core fuel assembly and the outer core fuel assembly illustrated in FIG. 6.

FIG. 8 is a vertical cross-sectional view of an inner core fuel assembly and an outer core fuel assembly related to the third embodiment of the present invention.

FIG. 9 is a vertical cross-sectional view of a core in a fast reactor on which the inner core fuel assembly and the outer core fuel assembly illustrated in FIG. 8 are loaded.

### DETAILED DESCRIPTION OF THE PREFERRED EMBODIMENTS

Hereinafter, examples of the present invention will be explained using the drawings.

### First Embodiment

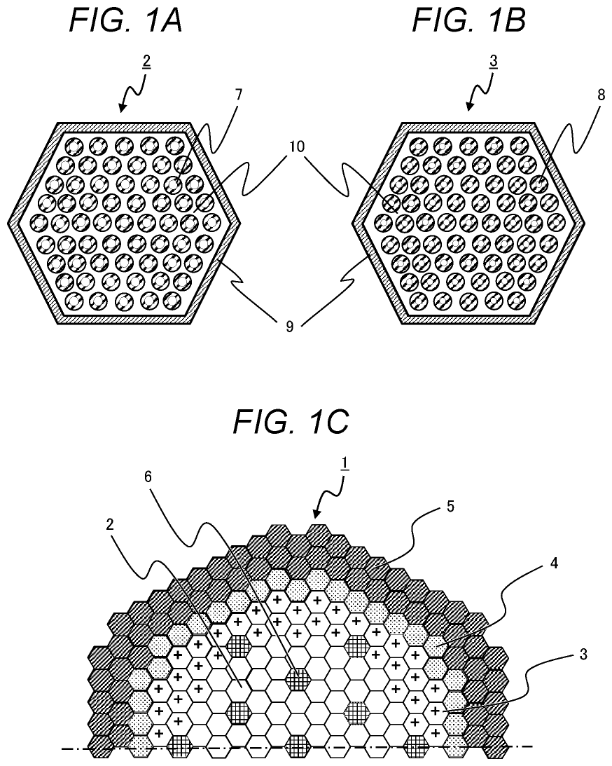

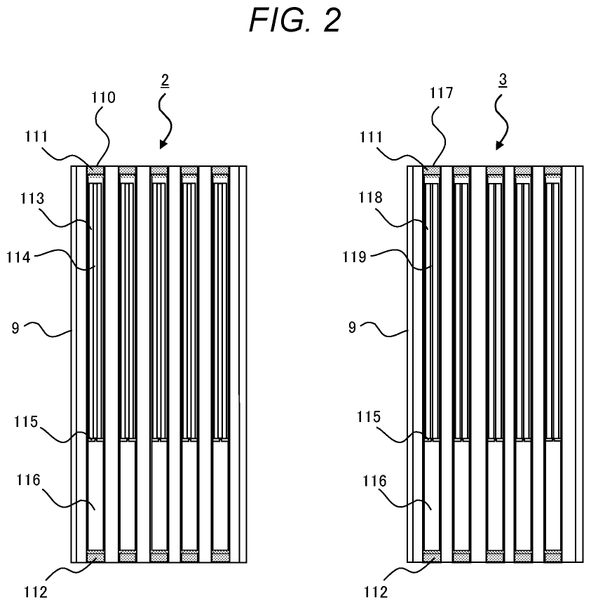

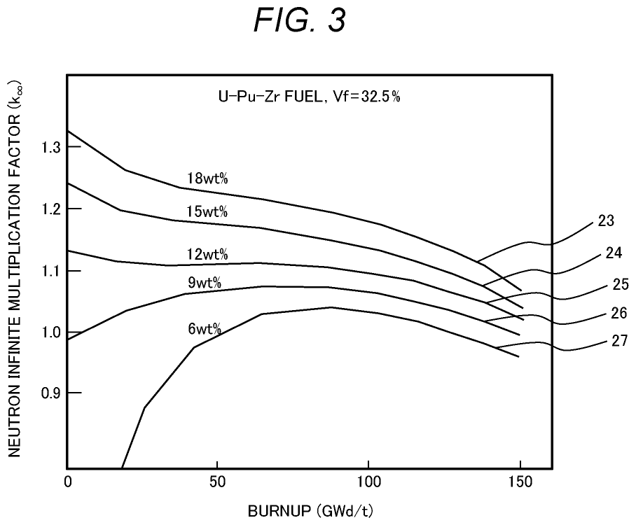

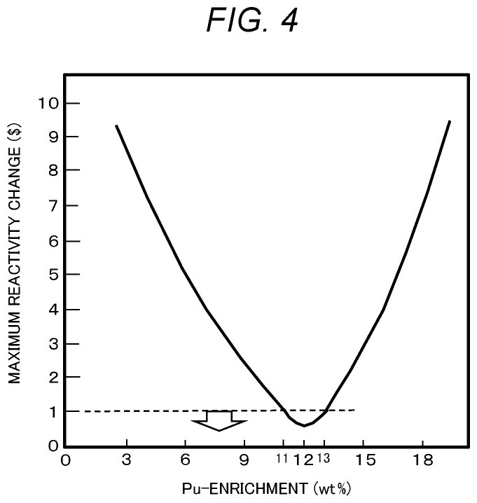

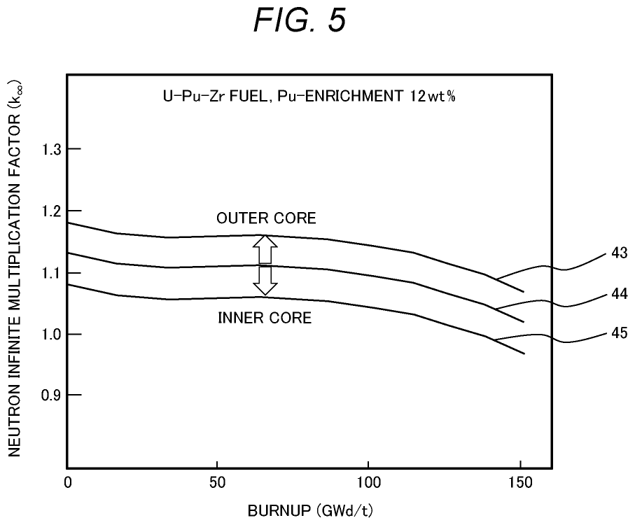

The present embodiment will be explained using FIG. 1A, FIG. 1B, and FIG. 1C illustrating a horizontal cross-sectional view of the core fuel assembly and ½ core in the fast reactor related to the present example, FIG. 2 illustrating a vertical cross-sectional view of the fuel assembly, FIG. 3 illustrating the burnup change of the neutron infinite multiplication factor of the core fuel assembly using the Pu-enrichment as a parameter, FIG. 4 illustrating the Pu-enrichment dependability of the maximum reactivity change during the burnup period of the core fuel assembly, FIG. 5 comparing the burnup change of the neutron infinite multiplication factor of the inner core fuel assembly and the outer core fuel assembly, and Table 1 showing the specification of the core fuel assembly.

The object of the present embodiment is a fuel assembly of a sodium-cooled metal fuel fast reactor and a core of a fast reactor on which the fuel assembly of the sodium-cooled metal fuel fast reactor is loaded, the fuel assembly of the sodium-cooled metal fuel fast reactor making the gap between the fuel alloy and the fuel cladding tube to be small to a degree similar to that of a MOX fuel core to enable He boding while making the smear density of the fuel equal to or less than 75% of that of the normal metal fuel and thereby achieving absorption of fuel swelling by using a hollow metal fuel.

FIG. 1A illustrates a horizontal cross-sectional view of an inner core fuel assembly related to the present embodiment, FIG. 1B illustrates a horizontal cross-sectional view of an outer core fuel assembly of the present embodiment, and FIG. 1C illustrates a horizontal cross-sectional view of a ½ core of the fast reactor where the inner core fuel assemblies and the outer core assemblies are loaded.

As illustrated in FIGS. 1A to 1C, with respect to an inner core fuel assembly 2, fuel rods (not illustrated) encapsulating an U—Pu—Zr alloy 7 having a hollow are triangular-pitch-densely arrayed within a wrapper tube 9 of a hexagonal shape made of stainless steel. A region 10 between the fuel rods 7 within the wrapper tube 9 (a region where coolant sodium circulates) is filled with sodium that is the coolant flowing upstream from the lower side of the fuel assembly. As an example, the pitch of the fuel assembly is 157.2 mm, the diameter of the fuel rod is 8.5 mm, the diameter of the hollow is 2.82 mm. Although FIGS. 1A to 1C are simplified, the number of piece of the fuel rod per one set of the fuel assembly is 217 pieces. The volume fraction of the fuel occupying the inner core fuel assembly 2 (inclusive of the gap between the fuel assembly) is 30.0%. On the other hand, an outer core fuel assembly 3 is different from the inner core fuel assembly 2 in a point that the diameter of the hollow of a U—Pu—Zr alloy (hollow metal fuel of the outer core fuel assembly) 8 having a hollow is as small as 2.27 mm. As a result, the volume fraction of the fuel in the outer core fuel assembly 3 is as large as 33.6%.

The structure in a height direction of the fuel assembly will be explained. FIG. 2 is a vertical cross-sectional view of the inner core fuel assembly and the outer core fuel assembly illustrated in FIG. 1A and FIG. 1B. As illustrated in FIG. 2, with a U—Pu—Zr fuel alloy (metal fuel of the inner core fuel assembly) 113 of a cylindrical shape having a hollow (a hollow of the metal fuel of the inner core fuel assembly) 114 being stored within a cladding tube having a cyrindrical pipe shape made of stainless steel, a fuel rod 110 loaded on the inner core fuel assembly 2 is disposed on a metal fuel support member 115 that is disposed in an upper portion of a gas plenum 116 holding a fission product FP in the form of a gas, and is encapsulated along with helium (He) gas with an upper end plug 111 and a lower end plug 112 being welded. A vertical length of the U—Pu—Zr alloy is 100 cm. The outer core fuel assembly 3 has similar structure and sizes also, but is different in terms that the diameter of a hollow 119 of an U—Pu—Zr fuel alloy (metal fuel of the outer core fuel assembly) 118 is smaller than the diameter of the hollow 114 of the U—Pu—Zr fuel alloy (metal fuel of the inner core fuel assembly) 113 of the inner core fuel assembly 2 as described above.

With respect to the fuel assembly of the fast reactor on which the metal fuel U—Pu—Zr is loaded, there is shown in FIG. 3 a result of plotting a result of calculating a curve of dependability of the neutron infinite multiplication factor (k_{∞}) with respect to the burnup (GWd/t) when the Pu-enrichment is used as a parameter by an analysis method of a fast reactor. Also, in FIG. 3, the burnup (GWd/t) is taken on the horizontal axis, the neutron infinite multiplication factor (k_{∞}) is taken on the vertical axis, and there are shown the curves of the neutron infinite multiplication factor 23 of 18 wt % of the Pu-enrichment, the neutron infinite multiplication factor 24 of wt % of the Pu-enrichment, the neutron infinite multiplication factor 25 of 12 wt % of the Pu-enrichment, the neutron infinite multiplication factor 26 of 9 wt % of the Pu-enrichment, and the neutron infinite multiplication factor 27 of 6 wt % of the Pu-enrichment. From FIG. 3, it is known that, when the Pu-enrichment is high, although the neutron infinite multiplication factor (k_{∞}) of the initial stage is large, since the conversion ratio is small and consumption of Pu exceeds generation, the dropping rate of the neutron infinite multiplication factor (k_{∞}) is large accompanying burnup. To the contrary, it is known that, when the Pu-enrichment is low, since the conversion ratio is large and generation of Pu exceeds consumption, although the neutron infinite multiplication factor (k_{∞}) of the initial stage is small, the increasing rate of the neutron infinite multiplication factor (k_{∞}) is large accompanying burnup. There is shown in FIG. 4 a drawing of marshaling the Pu-enrichment dependability of the change of the maximum reactivity throughout the burnup period of the fuel assembly based on FIG. 3, namely the drawing showing the Pu-enrichment dependability of the maximum reactivity change during the burnup period. From FIG. 4, with 1 (one) $ of reactivity (=effective delayed neutron fraction; defined to be approximately 0.3% of the case of a fast reactor using Pu as the fuel) being made an indication of the limit value, the range of the Pu-enrichment effecting small maximum reactivity change lower than said 1 (one) $ is the range of 11 wt % to 13 wt %. According to the present embodiment, so as to reach criticality when the Pu-enrichment is 12 wt % in particular out of the said range, the specification of the fuel assembly and the number of piece of the fuel assembly to be loaded on the core are set. In addition, it is required to bring the output of the outer core fuel assembly where the leakage amount of neutron is large close to the output of the inner core fuel assembly on the center side of the core.

According to the design of the core of a fast reactor of a conventional art, flattening of the output distribution in the radial direction of the core is achieved by making the Pu-enrichment of the outer core fuel assembly higher than the Pu-enrichment of the inner core fuel assembly. However, as illustrated in FIG. 3, since the burnup dependability of the neutron infinite multiplication factor (k_{∞}) of the fuel assembly largely differs when the Pu-enrichment changes, it is hard to maintain flattening of the output in the radial direction throughout the burnup cycle. Therefore, according to the present embodiment, as illustrated in FIG. 5, the Pu-enrichment of the metal fuel U—Pu—Zr alloy is maintained constant at 12 wt % and the fuel volume fraction of the outer core fuel assembly is made higher than the fuel volume fraction of the inner core fuel assembly, thereby the burnup dependability of the neutron infinite multiplication factor (k_{∞}) 45 with respect to the fuel volume fraction of the inner core fuel assembly and the burnup dependability of the neutron infinite multiplication factor (k_{∞}) 43 with respect to the fuel volume fraction of the outer core fuel assembly are made to be equal to each other and flattening of output sharing in the radial direction throughout the burnup cycle is maintained, thereby the useless flow rate is reduced and it is achieved to raise the coolant outlet temperature of the nuclear reactor. The fuel volume fraction of the inner core fuel assembly and the outer core fuel assembly is achieved by setting the diameter of the hollow of the metal fuel U—Pu—Zr alloy to be large in the inner core fuel assembly and to be small in the outer core fuel assembly as shown in TABLE 1. Also, the neutron infinite multiplication factor (k_{∞}) 44 of FIG. 5 expresses the burnup dependability of the average neutron infinite multiplication factor of the core.

TABLE 1
Outer core fuel

| | | Inner core fuel | Outer core fuel |
|---|---|---|---|
| Item | Unit | assembly | assembly |
| Fuel | mm | 157.2 | |
| assembly | | | |
| pitch | | | |
| Distance | mm | 153.0 | |
| between | | | |
| outside | | | |
| face of | | | |
| fuel | | | |
| assembly | | | |
| Fuel rod | pc | 217 | |
| number of | | | |
| piece | | | |
| Fuel rod | mm | 8.5 | 8.5 |
| cladding | | | |
| tube | | | |
| diameter | | | |
| Cladding | mm | 0.50 | 0.50 |
| tube | | | |
| thickness | | | |
| Metal fuel | mm | 6.88 | 6.88 |
| element | | | |
| outside | | | |
| diameter | | | |
| Gap between | mm | 0.16 | 0.16 |
| cladding | | | |
| tube and | | | |
| metal fuel | | | |
| (one side) | | | |
| Metal fuel | mm | 2.82 | 2.27 |
| element | | | |
| hollow | | | |
| diameter | | | |
| Smear | % TD | 70 | 75 |
| density | | | |
| within fuel | | | |
| rod | | | |
| cladding | | | |
| tube | | | |
| Fuel volume | vol % | 30.0 | 33.6 |
| fraction | | | |
| within | | | |
| assembly | | | |

According to the present embodiment, it is confirmed by a core calculation that the core fuel assemblies having the specification shown in TABLE 1 are loaded under the condition of the electric output 300 MW of the nuclear reactor, the thermal output 714 MW, and approximately 100 GWd/t of the discharge average burnup of the core fuel, thereby the output distribution in the radial direction is flattened and the temporal output fluctuation throughout the burnup cycle is minimized, and thereby the useless flow rate is reduced and the outlet temperature of the nuclear reactor coolant can be raised from approximately 500° C. to approximately 550° C.

Accordingly, adaptability to the heat storage system using the molten salt could be improved, thermal efficiency could be increased by raising the outlet temperature of the nuclear reactor coolant by approximately 50° C., and the effect of improving economic also could be secured.

As described above, according to the present embodiment, it is possible to provide a core of a fast reactor capable of achieving a sodium-cooled metal fuel fast reactor with high adaptability to a molten salt heat storage system by flattening the output distribution and raising the coolant outlet temperature while suppressing deterioration of the core characteristic.

Also, by using a hollow fuel where Pu-enrichment of a fuel loaded on a core fuel assembly of a fast reactor is made constant within a range of 11 to 13 wt %, loading fuel assemblies with a large hollow diameter of the hollow fuel on the center side of the core, and loading fuel assemblies with a small hollow diameter of the hollow fuel on the circumferential side of the core, it is possible to achieve a core of a sodium-cooled metal fuel fast reactor with high adaptability to a molten salt heat storage system suppressing spatial and temporal fluctuation of the output distribution, excluding useless flow rate, and raising the nuclear reactor coolant outlet temperature without deteriorating the characteristic of the core.

### Second Embodiment

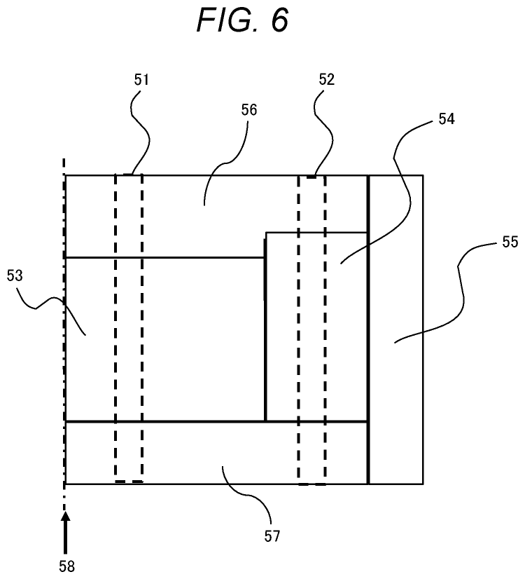

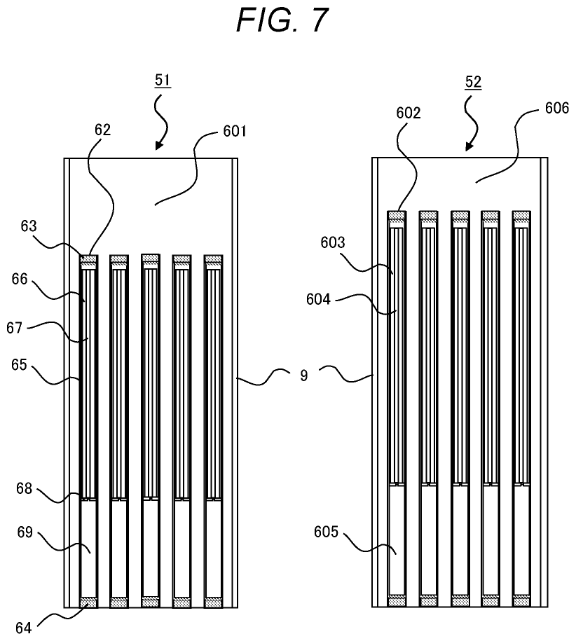

FIG. 6 is a vertical cross-sectional view of a core in a fast reactor related to the second embodiment of the present invention, and FIG. 7 is a vertical cross-sectional view of the inner core fuel assembly and the outer core fuel assembly illustrated in FIG. 6. The present embodiment is different from the first embodiment in terms that a sodium plenum configured of a wrapper tube and flowing sodium is disposed in an upper portion of a fuel rod storing a hollow metal fuel U—Pu—Zr in the inner core fuel assembly and the outer core fuel assembly.

As illustrated in FIG. 7, the structure of the core fuel assembly of the present embodiment is different from that of the first embodiment in terms that a sodium plenum 601 configured of the wrapper tube 9 and flowing sodium is disposed in an upper portion of a fuel rod 62 storing a hollow metal fuel U—Pu—Zr (metal fuel of the inner core fuel assembly) 66 similar to that illustrated in FIG. 2 in the first embodiment described above in an inner core fuel assembly 51. Also, a length in the vertical direction of a hollow metal fuel U—Pu—Zr alloy (metal fuel of the outer core fuel assembly) 603 stored in a fuel rod 602 in an outer core fuel assembly 52 is longer than a length in the vertical direction of the hollow metal fuel U—Pu—Zr alloy 66 of the inner core fuel assembly, and a height of a sodium plenum 606 is shorter by this elongated portion.

The layout drawing of the horizontal cross section of the core is the same as FIG. 1C of the first embodiment described above. The vertical cross-sectional view of the core is as per FIG. 6, a height of an inner core region 53 on which the inner core fuel assembly 51 is loaded is lower than a height of an outer core region 54 on which the outer core fuel assembly 52 is loaded, and a sodium plenum 56 is thick in the inner core region and is thin in the outer core region to the contrary. Since the sodium plenum 56 functions as a reflector of neutrons during the steady operation, the core characteristic is not spoiled, and the spatial and temporal output flattening effect similar to that of the first embodiment described above is exerted. Therefore, the effect of rising the coolant outlet temperature can be exerted also in the present embodiment.

In a ULOF (Unticipated Loss of Flow) assuming a scram failure of the fast reactor, the coolant temperature at the fuel region upper end of the core fuel assembly rises at first at the time of the loss of the flow and the density of liquid sodium coolant reduces, therefore the leakage amount of neutron to the sodium plenum at the core fuel upper end and the upper side thereof increases, large negative reactivity is applied, and therefore increase of the reactivity and the reactor power is suppressed. According to the present embodiment, the height of the core fuel of the inner core region where contribution to the void reactivity is large is low and the absolute value of the negative reactivity applied described above increases, therefore the net reactivity becomes negative, coolant sodium can be avoided from boiling at the time of ULOF, and an effect of improving inherent safety is secured.

As described above, according to the present embodiment, in addition to the effect of the first embodiment, the effects of being capable of avoiding boiling of the coolant sodium at the time of ULOF and improving inherent safety are secured.

### Third Embodiment

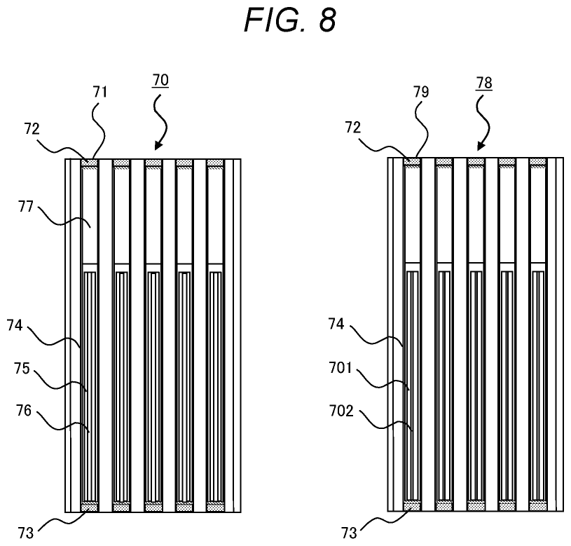

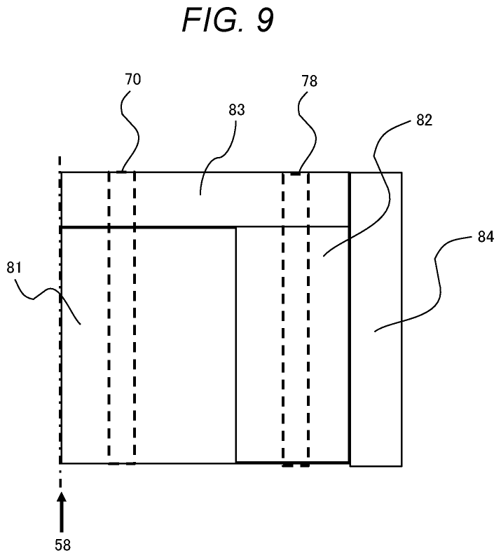

FIG. 8 is a vertical cross-sectional view of an inner core fuel assembly and an outer core fuel assembly related to the third embodiment of the present invention, and FIG. 9 is a vertical cross-sectional view of a core in a fast reactor on which the inner core fuel assembly and the outer core fuel assembly illustrated in FIG. 8 are loaded. The present embodiment is different from the first embodiment in terms that the gap between the hollow metal fuel and the cladding tube is set wide and the metal fuel is immersed in Bonded sodium of a liquid state in order to improve the gap conductance.

As illustrated in FIG. 8, with respect to a fuel rod 71 of an inner core fuel assembly 70, a hollow metal fuel U—Pu—Zr alloy 75 similar to the first embodiment described above is stored in a cladding tube 74 made of stainless steel, and is sealed by an upper end plug 72 and a lower end plug 73. The point different from the metal fuel of the first embodiment is that the gap between the hollow metal fuel U—Pu—Zr alloy 75 and the cladding tube 74 is set wide and the metal fuel is immersed in Bonded sodium of the liquid state in order to improve the gap conductance. Although the structure of an outer core fuel assembly 78 is similar, it is different from that of the inner core fuel assembly 70 in terms that the diameter of a hollow 702 of a hollow metal fuel alloy 701 of the outer core fuel assembly is smaller than the diameter of a hollow 76 of the hollow metal fuel alloy 75 of the inner core fuel assembly similarly to the first embodiment. The fuel volume fraction in the inner core fuel assembly 70 and the outer core fuel assembly 78 is the same as that shown in TABLE 1 of the first embodiment described above.

The vertical cross-sectional view of the core is as per FIG. 9, the inner core fuel assembly 70 illustrated in FIG. 8 is loaded on the inner core region 81, and the outer core fuel assembly 78 is loaded on the outer core region 82. Differently from the first embodiment and the second embodiment, a gas plenum region 83 is disposed in the upper portion of the core fuel region. Also, the different point from the second embodiment is that the inner core region and the outer core region are the same in a height of the core fuel.

According to the present embodiment, the metal fuel is stored in the cladding tube in a state of being immersed in the bonded sodium of a liquid state having high thermal conductivity, the temperature of the metal fuel at the time of the steady operation is made lower than that of the first embodiment and the second embodiment described above, is made to track the coolant temperature at the time of the transition, and therefore, when the coolant temperature rises at the time of the ULOF in particular, it can be expected that large negative Doppler reactivity is applied, and inherent safety improves.

As described above, according to the present embodiment, in addition to the effect of the first embodiment, when the coolant temperature rises at the time of the ULOF, it can be expected that large negative Doppler reactivity is applied, and intrinsic safety can be improved.

Although sodium was used as the coolant in the first embodiment to the third embodiment described above, the same effect can be achieved even when lead or lead-bismuth is used. Further, although the metal fuel U—Pu—Zr alloy was used as the fuel, the same effect can be achieved even when a MOX fuel and a nitride fuel are used. Also, a similar effect is secured for an optional combination of each coolant and each fuel described above.

Also, the present invention is not limited to the embodiments described above, and includes various modifications. For example, the embodiments described above were explained in detail for easy understanding of the present invention, and it is not necessarily limited to one including all configurations having been explained. Also, a part of a configuration of an embodiment can be substituted by a configuration of other embodiments, and a configuration of an embodiment can be added with a configuration of other embodiments.

### REFERENCE SIGNS LIST

1: ½ core of fast reactor
2: inner core fuel assembly
3: outer core fuel assembly
4: radial direction blanket fuel assembly
5: shield assembly
6: control rod assembly
7: hollow metal fuel of inner core fuel assembly
8: hollow metal fuel of outer core fuel assembly
9: wrapper tube
10: region where coolant sodium circulates
23: neutron infinite multiplication factor of Pu-enrichment 18 wt %
24: neutron infinite multiplication factor of Pu-enrichment 15 wt %
25: neutron infinite multiplication factor of Pu-enrichment 12 wt %
26: neutron infinite multiplication factor of Pu-enrichment 9 wt %
27: neutron infinite multiplication factor of Pu-enrichment 6 wt %
43: neutron infinite multiplication factor for fuel volume fraction of outer core fuel assembly
44: neutron infinite multiplication factor for fuel volume fraction of core average neutron infinite multiplication factor for fuel volume fraction of inner core fuel assembly
51, 70: inner core fuel assembly
52, 78: outer core fuel assembly
53, 81: inner core region
54, 82: outer core region
84: shield assembly
56, 601, 606: sodium plenum
57, 69, 77, 83, 116, 605: gas plenum
58: center
62, 71, 110: fuel rod of inner core fuel assembly
63, 72, 111: upper end plug
64, 73, 112: lower end plug
74: cladding tube
66, 75, 113: metal fuel of inner core fuel assembly
67, 76, 114: hollow of metal fuel of inner core fuel assembly
68, 115: metal fuel support member
79, 117, 602: fuel rod of outer core fuel assembly
118, 603, 701: metal fuel of outer core fuel assembly
119, 604, 702: hollow of metal fuel of outer core fuel assembly

What is claimed is:

1. A core of a fast reactor, the core being a fuel assembly obtained by densely disposing fuel rods within a wrapper tube, the fuel rod storing, within a cladding tube, hollow fuel in which Pu-enrichment is made to be a predetermined value within a range of 11 to 13 wt %, wherein
a first fuel assembly including a fuel rod with a large hollow diameter of the hollow fuel is loaded on the center side of the core, and
a second fuel assembly including a fuel rod with a hollow diameter smaller than the hollow diameter of the hollow fuel of the first fuel assembly is loaded on the circumferential side of the core.

2. The core of a fast reactor according to claim 1, wherein
the hollow fuel is a metal fuel alloy of U—Pu—Zr.

3. The core of a fast reactor according to claim 1, wherein
a sodium plenum configured of a wrapper tube and flowing sodium is provided in an upper portion of the fuel rod,
a length of a hollow fuel of the first fuel assembly is shorter than a length of a hollow fuel of the second fuel assembly, the hollow fuel of the first fuel assembly being a hollow U—Pu—Zr metal fuel alloy, the hollow fuel of the second fuel assembly being a hollow U—Pu—Zr metal fuel alloy, and
a height of a sodium plenum of the first fuel assembly is higher than a height of a sodium plenum of the second fuel assembly.

4. The core of a fast reactor according to claim 2, wherein
a sodium plenum configured of a wrapper tube and flowing sodium is provided in an upper portion of the fuel rod,
a length of a hollow U—Pu—Zr metal fuel alloy of the first fuel assembly is shorter than a length of a hollow U—Pu—Zr metal fuel alloy of the second fuel assembly, and
a height of a sodium plenum of the first fuel assembly is higher than a height of a sodium plenum of the second fuel assembly.

5. The core of a fast reactor according to claim 3, wherein
a total of a length of the hollow U—Pu—Zr metal fuel and a height of the sodium plenum is equal between the first fuel assembly and the second fuel assembly.

6. The core of a fast reactor according to claim 4, wherein
a total of a length of the hollow U—Pu—Zr metal fuel and a height of the sodium plenum is equal between the first fuel assembly and the second fuel assembly.

7. The core of a fast reactor according to claim 1, wherein
the hollow fuel is a hollow U—Pu—Zr metal fuel alloy, and is a fuel rod obtained by immersing the hollow U—Pu—Zr metal fuel alloy in bonded sodium.

8. The core of a fast reactor according to claim 2, wherein
the hollow fuel is a fuel rod obtained by immersing the hollow U—Pu—Zr metal fuel alloy in bonded sodium.

9. The core of a fast reactor according to claim 1,
wherein
burnup dependability of a neutron infinite multiplication factor for a fuel volume rate of the first fuel assembly and burnup dependability of a neutron infinite multiplication factor for a fuel volume fraction of the second fuel assembly are made to be the same, and flattening of output sharing in the radial direction throughout a burnup cycle is maintained.

10. The core of a fast reactor according to claim 2, wherein
burnup dependability of a neutron infinite multiplication factor for a fuel volume fraction of the first fuel assembly and burnup dependability of a neutron infinite multiplication factor for a fuel volume fraction of the second fuel assembly are made to be the same, and flattening of output sharing in the radial direction throughout a burnup cycle is maintained.
